(19) United States
(12) Patent Application Publication
(10) Pub. No.: US 2014/0176363 A1
(43) Pub. Date: Jun. 26, 2014

(54) METHOD OF MONITORING WEAPONS USING A GPS DEVICE THAT IS STRAPPED ONTO THE WEAPON

(71) Applicants: Vinh Minh Glisttenmeer Lam, Hayward, CA (US); Ethan Lam, Fremont, CA (US); Megan Lam, Fremont, CA (US)

(72) Inventors: Vinh Minh Glisttenmeer Lam, Hayward, CA (US); Ethan Lam, Fremont, CA (US); Megan Lam, Fremont, CA (US)

(73) Assignee: VICTOR LAM, Fremont, CA (US)

(21) Appl. No.: 13/726,570

(22) Filed: Dec. 25, 2012

(51) Int. Cl. G01S 19/01

(52) U.S. Cl. CPC G01S 19/01
USPC 342/357.39

(57) ABSTRACT

A method for tracking extremely dangerous weapons, such as assault rifles, is described. This method comprises of a GPS device which is strapped onto the weapon, such as the assault rifle's neck. The position of the GPS, along with the location of the weapon is constantly monitored. If the position of the GPS and weapon is near a school, an alarm signal is sent to a Global Position Processing Center. The Center then immediately contact and inform the school and the local police department about the position of the weapon by its GPS positional signal. If the GPS is disabled, an alarm signal is sent to the Center. The Center then investigates the reason for its disablement. If the disablement of the GPS is illegal, then the Center will contact the local police for further investigation of the weapon. In this way, dangerous weapons, such as assault rifles, are kept track of and schools are alerted when such weapons come within its safety perimeter. By this method, law enforcement agencies can pursue missing weapons and account for all dangerous weapons and their locations.

### BACKGROUND OF THE INVENTION

1. Description of the Prior Art

2. References Cited

| Patent Number | Date | Inventor | Field |
|---|---|---|---|
| 3,530,451 | September 1970 | Devine | 340/568 |
| 3,750,131 | July 1973 | Fletcher et al | 340/574 |
| 4,936,037 | June 1990 | Holcomb et | 42/106 |
| | | al | |
| 5,108,019 | April 1992 | Woodward | 224/243 |
| | | et al | |
| 5,218,344 | June 1993 | Ricketts | 340/573 |
| 5,365,217 | November 1994 | Toner | 340/574 |
| 5,479,149 | December 1995 | Pike | 340/574 |
| 5,525,966 | Jun. 11, 1996 | Parish | 340/568 |
| 5,715,623 | Feb. 10, 1998 | Mackey | 42/70.01 |
| 5,828,301 | Oct. 27, 1998 | Sanchez | 340/539.1 |
| 6,408,555 | Jun. 25, 2002 | Sapia et al | 42/70.07 |
| 6,415,542 | Jul. 9, 2002 | Bates et al | 42/70.11 |
| 6,641,009 | Nov. 4, 2003 | French et al | 224/244 |
| 7,389,604 | Jun. 24, 2008 | Newkirk et | 42/70.11 |
| | | al | |
| 7,714,720 | May 11, 2010 | Hietanen et | 340/568.1 |
| | | al | |
| 7,737,841 | Jun. 15, 2010 | Derrick et al | 340/539.13 |
| 7,936,262 | May 3, 2011 | Derrick et al | 340/539.13 |
| 8,013,736 | Sep. 6, 2011 | Derrick et al | 340/539.13 |
| 8,031,077 | Oct. 4, 2011 | Derrick et al | 340/539.13 |

There is a need in society for tracking and monitoring the locations of extremely dangerous weapons, such as assault rifles, weapons capable of discharging many bullets in a short period of time and other high power guns. This need arises from the many horrific incidents where these dangerous weapons were used to commit horrific crimes. As of yet, there has been no system or method for keeping track of these dangerous weapons. The prior arts have proposed trigger locks, electronic trigger locks, GPS embedded in the holster, and other means of preventing these weapons from being used to commit crimes. However, no one has yet proposed a comprehensive system or method for keeping track of these weapons, where the GPS device is attached to the weapon, which the gun-owner community finds such modification acceptable.

The gun owner community has been reluctant in adopting any monitoring system whereby GPS devices are embedded into weapons, impeding the progress of monitoring these dangerous weapons. The prior art has proposed embedding GPS devices into the holster of the weapon, but the weapon can be removed from the holster, defeating the purpose of tracking it. The prior art has also proposed integrating the GPS device in such a way that an alarm is sent to monitoring stations when the GPS device inside the weapon is located in a restricted area. The problem with integrating the device inside the weapon incurs higher cost in manufacturing the weapon, as well as greater complexity, which impose a disincentive for weapon manufacturer to adopt a system of embedding the GPS device inside the weapon. Furthermore, as GPS technology changes, the GPS device inside the weapon may have to be removed and replaced, creating difficulties and problems for gun-owners to service the GPS device.

To resolve these problems, our invention proposes a method in which the GPS device is strapped onto the weapon. Furthermore, the GPS device has a simpler function in which it only sends its position to a Processing Center. The Center will analyze the position and alert local law enforcement agencies. In this way, the GPS device can be as simple and as small as possible. The prior art has also proposed electronic trigger locks, which tend to be expensive and impede the free use of the weapon, to which gun-owners also opposed. Trigger locks impede the use of the weapon in emergency situations, and many gun-owners are unwilling to install trigger locks. There is a need for a method or system to track these dangerous weapons in which gun-owners will readily accept. This invention will describe a method by which these dangerous weapons can be tracked and monitored at all times and which gun-owners will readily accept. This method of tracking dangerous weapons will prevent these weapons from coming anywhere near schools or other public facilities.

### SUMMARY OF THE INVENTION

This invention comprises of a method of monitoring and tracking dangerous weapons, such as assault rifles. The method comprises of a GPS device which is strapped onto the weapon. The preferred attachment of the GPS device is around the neck of the assault rifle. The method also comprises a GPS Position Processing Center, which receives the signal from the GPS device, allowing the Center to track the location of the weapon. The Center will notify law enforcement agencies, such as the local Police Department, when the weapon's GPS device enters the safety zone boundary of a school. The Center will also simultaneously notify the school. At which point, the local police departments will investigate and take actions to prevent the weapon from entering school ground.

If the GPS device is disabled, the GPS Position Processing Center will become alerted because the GPS device has stopped sending signal to the center. If the strap of the GPS device is cut, a signal will also be sent to the Center. At which point, the Center will investigate, and if the GPS device is not re-activated and re-attached to the weapon, the Center will notify local law enforcement agencies to investigate and confiscate the weapon.

### BRIEF DESCRIPTION OF THE FIGURES

FIG. 1 shows the attachment point of the GPS device to an example of a dangerous weapon. In this case, the GPS device is strapped around the neck of an assault rifle.

FIG. 2 shows an isometric view of the GPS device with strap.

FIG. 3 shows the information flow between the GPS device, which is strapped to the weapon, the police department or local law enforcement agencies, and the school. The line indicates information flows between different parties and agencies. When the GPS device and weapon enter the boundary of the school zone, a signal is sent to alert all parties and agencies to investigate and take actions to prevent the weapon from entering the school ground.

### DESCRIPTION OF PREFERRED EMBODIMENT

This invention describes a method for alerting schools when an extremely dangerous weapon approaches and enters its safety zone boundary. This method comprises of a GPS device, which is strapped onto a weapon, a GPS Position Processing Center, which tracks and monitors the position of the weapon, and a system of alerting law enforcements and schools when such a weapon enters the safety zone of a school.

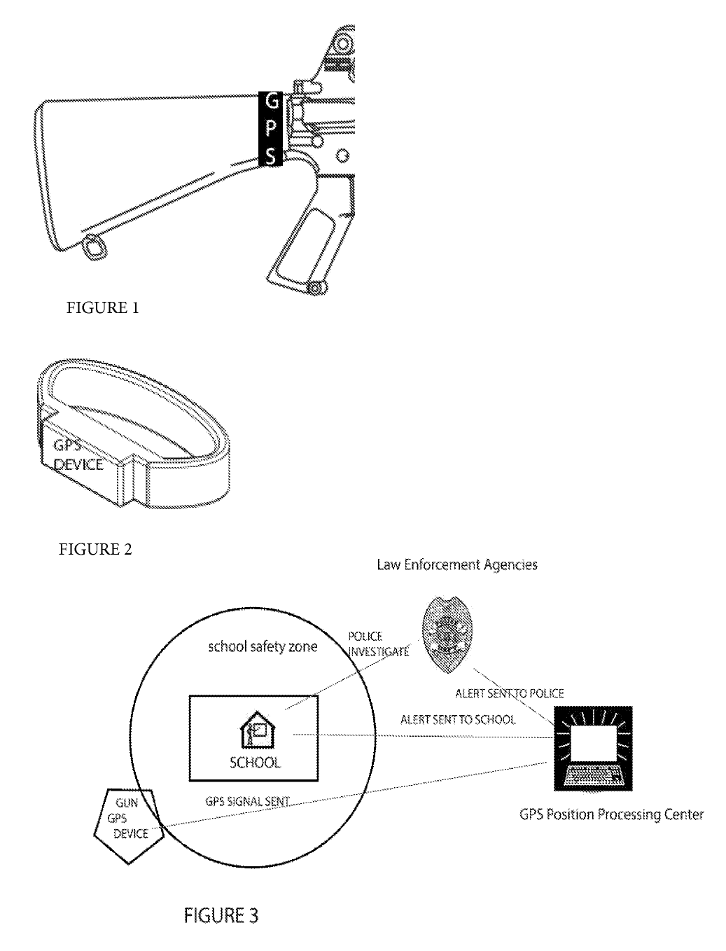

FIG. 1 shows a typical assault rifle with a GPS device strapped around the neck of the rifle. The prefer point of attachment of the GPS Device should be in a location that does not interfere with using it. The neck of the rifle is the best location to strap the device. Strapped to the neck of the rifle, the GPS device cannot be easily removed. Furthermore, the GPS device at this location imposes little interference to gun-owners, which will make it more acceptable for gun-owners to use this method of tracking their weapons.

FIG. 2 shows the GPS device with its strap. The prefer material for the strap should be a very strong material that cannot be cut by scissors or other readily available cutting devices, such as knives or cable cutter. Furthermore, the strap should be designed in such a way, that once it is strapped onto the weapon, it locks onto itself, so that it cannot be taken apart or removed unless by an authorized technician. If the strap is cut, tampered with, or damaged, an alert signal is sent to the Processing Center. The Processing Center will investigate the reason for the damaged strap. If the investigation is unsatisfactory, the Center will notify law enforcement agencies to track down and impound the weapon. Likewise, if the GPS device is disabled for any reason, the Processing Center will also investigate and alert the gun-owner to re-activate the GPS device or replace the GPS device on the weapon. If the gun-owner refuses or is unable to do so, an alert signal is sent to the local law enforcement agencies to investigate and impound the weapon if necessary.

This method is schematically described by FIG. 3. When a gun with the GPS device approaches a school, the Processing Center will be on alert to carefully monitor its location. The GPS device is constantly sending positional signals to the Processing Center. When the GPS device and weapon enter a designated boundary or safety zone around a school, the Processing Center will immediately alert local law enforcement agencies as well as officials of the school and the administrators of the school district. The preferred extent of the safety boundary zone around the school should be at least 1000 yards in order to give time to school officials to react and take actions. A 1000 yard boundary will also allow law enforcement agencies enough time to respond and detain the gun-owner before the weapon enters the school ground. The Processing Center will carefully monitor the location of the weapon as it approaches the school, giving second by second position of its location to local school and law enforcement officials. In this way, actions can be taken to lock down the school, and protect the school, allowing law enforcement agencies enough time to detain the weapon and its owner.

1. A GPS Device that is strapped onto the weapon.

2. A GPS Position Processing Center that receives positional signals of the weapon from the GPS Device.

3. When the GPS Device of the weapon comes within the safety zone boundary of a school, the GPS Position Processing Center will alert local law enforcement agencies as well as school officials and administrators of the school district.
